(19) United States
(12) Patent Application Publication
(10) Pub. No.: US 2015/0095048 A1
(43) Pub. Date: Apr. 2, 2015

(54) AUTOMATED, CUSTOMIZABLE INCOMING REFERRAL PROCESS

(71) Applicant: ALLSCRIPTS SOFTWARE, LLC, Chicago, IL (US)

(72) Inventors: Gary Fleischman, Waltham, MA (US); Kristin Brody, South Grafton, MA (US); Eugenia Chudinova, Acton, MA (US); Olga Podshivalova, Newton Center, MA (US); Thomas Dooley, South Hamilton, MA (US); Jermie Cullip, Groton, MA (US); Angela Pope, Zanesville, OH (US); Lisa Gillis, Canton, MA (US)

(73) Assignee: ALLSCRIPTS SOFTWARE, LLC, Chicago, IL (US)

(21) Appl. No.: 14/043,414

(22) Filed: Oct. 1, 2013

(51) Int. Cl. G06Q 50/22; G06Q 10/06

(52) U.S. Cl. CPC G06Q 50/22; G06Q 10/06311
USPC 705/2

(57) ABSTRACT

A computer-implemented method of using task lists to manage incoming referrals in a medical care organization includes presenting a task manager configured to visually create and assign lists of work corresponding to an incoming referral process, and receiving input corresponding to visual creation and assignment of a list of work corresponding to an incoming referral process. The method further includes presenting a wait list manager configured to visually create a wait list entry based upon an incoming referral in a medical care organization, and receiving input, based on the incoming referral, corresponding to creation of a wait list entry. The method also includes creating the wait list entry based upon the incoming referral input, creating one or more tasks based upon the wait list entry, and automatically managing and tracking the tasks created based upon the wait list entry, thereby driving the incoming referral process.

### INCORPORATION BY REFERENCE

The present application incorporates herein by reference the entire disclosure of commonly-owned U.S. patent application Ser. No. 13/841,224 (the “'224 application”), filed Mar. 15, 2013 and entitled “VISUAL WORKFLOW SYSTEMS AND METHODS.” A copy of the '224 application is attached hereto as Appendix A and is likewise incorporated herein by reference.

### COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### BACKGROUND OF THE INVENTION

The present invention generally relates to an automated, customizable incoming referral process within a healthcare organization.

The current state of the art does not allow for the Incoming Referral process to be driven by tasks created using user-defined criteria.

The problem faced prior to this innovation was the inability to drive the Incoming Referral process through the use of tasks. The non-task-based approach for the Incoming Referral process resulted in a lack of accountability for who was supposed to perform the next activity on the Incoming Referral (e.g., modifying a triage status). The new task-based approach resolves this ambiguity.

### SUMMARY OF THE INVENTION

The present invention includes many aspects and features. Moreover, while many aspects and features relate to, and are described in, the context of an automated, customizable incoming referral process, the present invention is not limited to use only in an automated, customizable incoming referral process, as will become apparent from the following summaries and detailed descriptions of aspects, features, and one or more embodiments of the present invention.

Accordingly, one aspect of the present invention relates to a computer-implemented method of using task lists to manage incoming referrals in a medical care organization. An exemplary such method includes presenting, to a user via a display screen associated with a first electronic device, a user interface of a task manager configured to visually create and assign lists of work corresponding to an incoming referral process; receiving, from a user via one or more input devices associated with the first electronic device, input corresponding to visual creation and assignment of a list of work corresponding to an incoming referral process; presenting, to a user via a display screen associated with a second electronic device, a user interface of a wait list manager configured to visually create a wait list entry based upon an incoming referral in a medical care organization; receiving, from a user via one or more input devices associated with the second electronic device, input, based on the incoming referral, corresponding to creation of a wait list entry; creating the wait list entry based upon the incoming referral input; creating one or more tasks based upon the wait list entry; and automatically managing and tracking, by a runtime software component based at least in part on the received input corresponding to visual creation and assignment of a list of work, the tasks created based upon the wait list entry, thereby driving the incoming referral process.

In a variation of this aspect, the step of automatically managing and tracking the tasks based upon the wait list entry includes assigning tasks to specific people based on criteria received as part of the input corresponding to the visual creation and assignment of the list of work.

In a feature of this aspect, the context of at least one of the one or more tasks that are created is based on the wait list entry.

In another feature of this aspect, the wait list entry is an outpatient service wait list entry, and wherein the wait list entry is displayed visually via the user interface of the wait list manager in an outpatient service wait list.

In another feature of this aspect, the wait list entry is an elective surgery wait list entry, and wherein the wait list entry is displayed visually via the user interface of the wait list manager in an elective surgery wait list.

In another feature of this aspect, the step of automatically managing and tracking the tasks includes updating the wait list entry status based on the execution of activities related to the task. In a further feature, the step of automatically managing and tracking the tasks includes updating the wait list entry status based on a patient appointment. In further variations, the step of automatically managing and tracking the tasks includes updating the wait list entry status based on an appointment for an outpatient service; the step of automatically managing and tracking the tasks includes updating the wait list entry status based on an appointment for elective surgery; the step of automatically managing and tracking the tasks includes updating the wait list entry status based on an appointment for pre-admittance testing; the step of automatically managing and tracking the tasks includes updating the wait list entry status based on the creation of a patient appointment; the step of automatically managing and tracking the tasks includes updating the wait list entry status based on a patient arrival visit; the step of automatically managing and tracking the tasks includes updating the wait list entry status based on a patient discharge visit; and/or the step of automatically managing and tracking the tasks includes updating the wait list entry status based on the creation of a patient appointment.

In another feature of this aspect, the method further includes a step of initializing a clock in conjunction with the step of creating the wait list entry. In further features, the clock measures time in units of days; and/or the clock is used to measure the length of time required for completion of at least one task.

In another feature of this aspect, the step of automatically managing and tracking the tasks based upon the wait list entry includes evaluating, after a task has been performed by a specific person, the incoming referral against user-defined criteria to determine further action. In further features, the further action includes marking the task as complete; and/or the further action includes reassigning the task to a different person.

In addition to the aforementioned aspects and features of the present invention, it should be noted that the present invention further encompasses the various possible combinations and subcombinations of such aspects and features. Thus, for example, any aspect may be combined with an aforementioned feature in accordance with the present invention without requiring any other aspect or feature.

### BRIEF DESCRIPTION OF THE DRAWINGS

One or more preferred embodiments of the present invention now will be described in detail with reference to the accompanying drawings, wherein the same elements are referred to with the same reference numerals, and wherein,

FIG. 1 is a high-level flowchart illustration of three processes in an exemplary Incoming Referral life cycle as it pertains to Wait List integration, all in accordance with one or more aspects of the present invention;

FIG. 2A is an expanded flowchart of the intake process of FIG. 1;

FIG. 2B is an expanded flowchart of the outpatient service process of FIG. 1;

FIG. 2C is an expanded flowchart of the elective surgery process of FIG. 1;

FIG. 3 is a screenshot of a first exemplary task definition screen in a graphical user interface in accordance with one or more aspects of the present invention;

FIG. 4 is a screenshot of a second exemplary task definition screen in a graphical user interface in accordance with one or more aspects of the present invention; and

FIG. 5 is a screenshot of a portion of a screen in an exemplary graphical user interface for an enterprise registration application in accordance with one or more aspects of the present invention.

### DETAILED DESCRIPTION

As a preliminary matter, it will readily be understood by one having ordinary skill in the relevant art (“Ordinary Artisan”) that the present invention has broad utility and application. As should be understood, any embodiment may incorporate only one or a plurality of the above-disclosed aspects of the invention and may further incorporate only one or a plurality of the above-disclosed features. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. As should be understood, any embodiment may incorporate only one or a plurality of the above-disclosed aspects of the invention and may further incorporate only one or a plurality of the above-disclosed features. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention, which scope is to be defined by the claims and the equivalents thereof. It is not intended that the scope of patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

Regarding applicability of 35 U.S.C. §112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

Referring now to the drawings, one or more preferred embodiments of the present invention are next described. The following description of one or more preferred embodiments is merely exemplary in nature and is in no way intended to limit the invention, its implementations, or uses.

An Incoming Referral (“IR”) is the recommendation of a medical or paramedical professional to provide a service to a patient presenting at the hospital where the service is being provided. An Incoming Referral has a life cycle that is related to its various statuses, and each status may require a different person with a different skill and/or responsibility to perform some action upon it before it can move further into its life cycle. In at least some embodiments, task lists are used to help ensure that the correct person is notified and/or held accountable for performing the correct action upon the Incoming Referral.

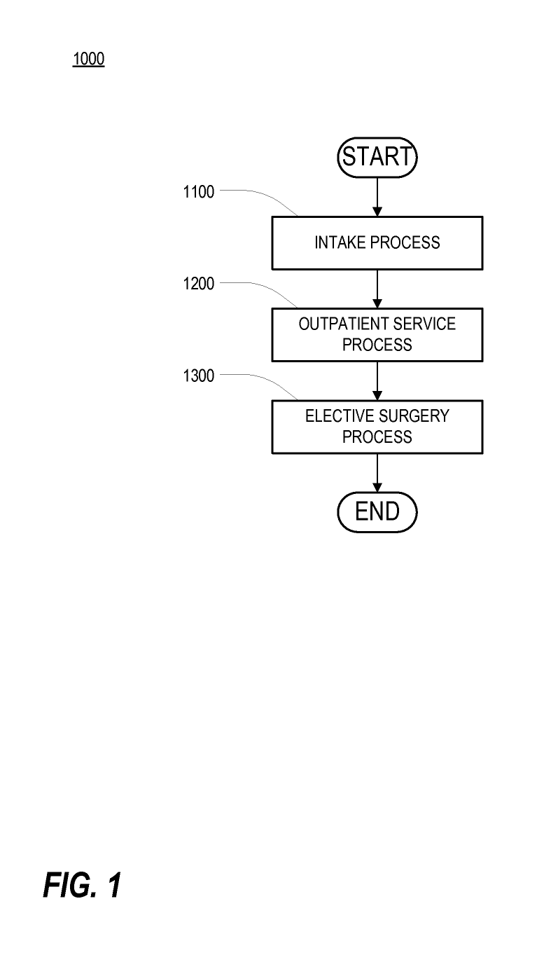

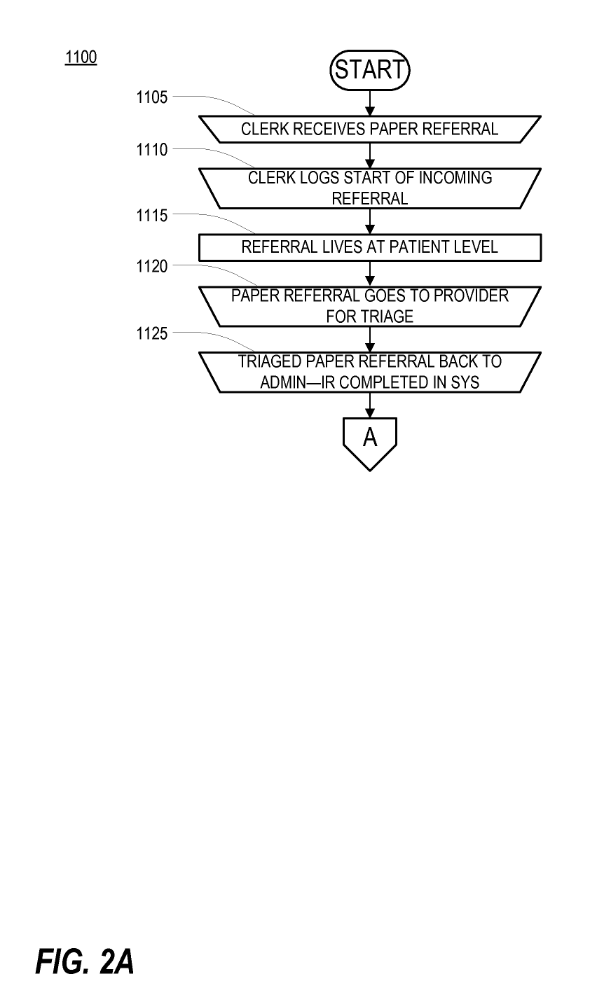

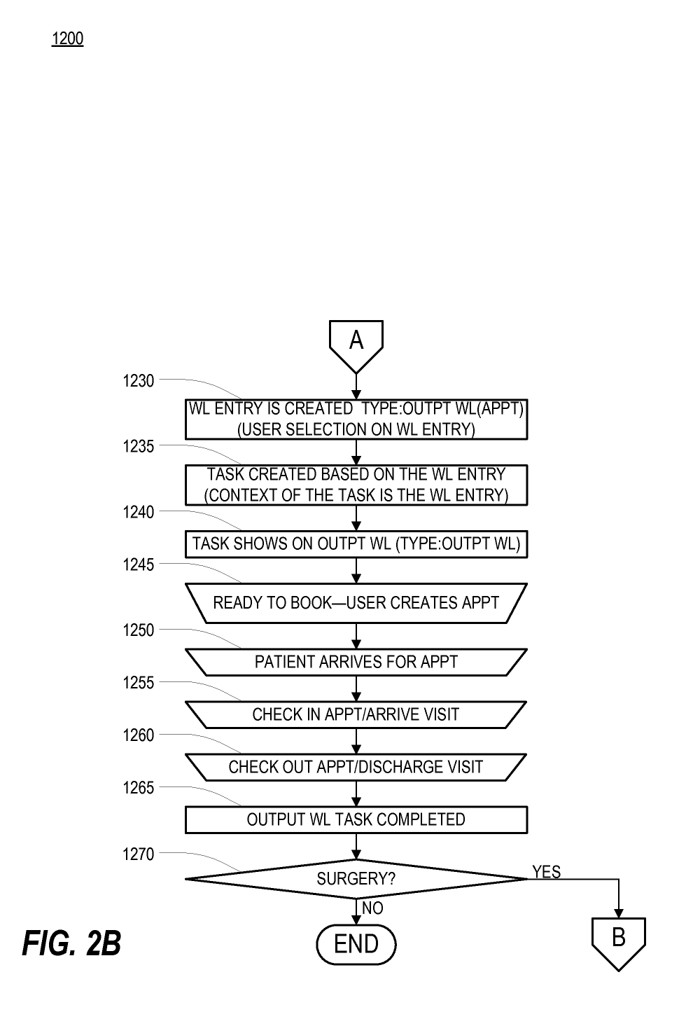

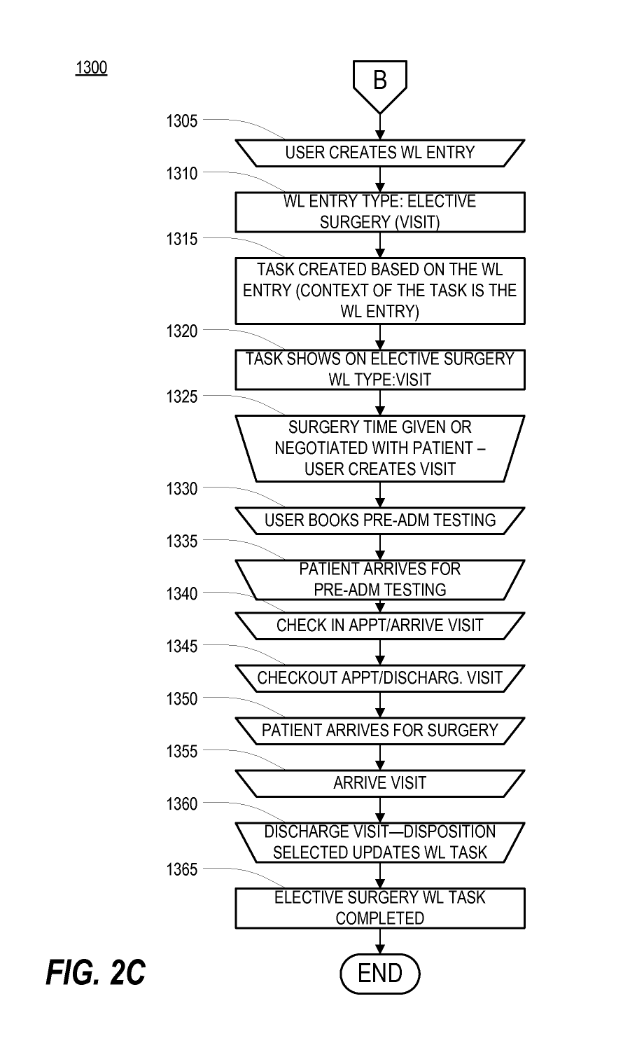

The use of task lists in the Incoming Referral life cycle 1000 is illustrated in FIG. 1 and FIGS. 2A, 2B and 2C. More particularly, FIG. 1 is a high-level flowchart illustration of three subprocesses in an exemplary Incoming Referral life cycle 1000 as it pertains to Wait List integration, all in accordance with one or more aspects of the present invention. This may be referred to as “Basic System Flow SA Outpatient to Elective Surgery WL.” Two large categories of services to be provided are outpatient services and elective surgery services, but their steps, though somewhat similar, have some differences. Thus, the life cycle 1000 includes three related and/or connected processes: an intake process 1100, shown in FIG. 2A; an outpatient service process 1200, shown in FIG. 2B; and an elective surgery process 1300, shown in FIG. 2C. In the life cycle 1000 shown in FIG. 1, outpatient services are managed first (via the outpatient process service 1200), but it will be appreciated that the outpatient service process 1200 and the elective surgery process 1300 may be reversed in order, overlapped with each other, or the like, all without departing from the scope of the present invention.

As shown in FIG. 2A, the referral intake process 1100 begins at step 1105 when an admin clerk receives a paper referral. At step 1110, the clerk logs the start of the incoming referral. The referral definition itself (“REFERRAL”), which lives at the patient level, is shown at step 1115. At step 1120, the paper referral goes to the provider for triage, and at step 1125 the triaged paper returns to admin where the IR is completed in the system.

As shown in FIG. 2B, the outpatient service process 1200 begins at step 1230 with the creation of an outpatient Wait List entry (“WL Entry”). In at least some embodiments, this is defined to the system as being a WL Entry of Type:Outpt WL (appt), and such type may be selected by the user during the creation process. Although not shown, a clock (“CLOCK”) is preferably initiated in conjunction with the creation of the WL Entry; in at least some embodiments, the calculation of or by the clock is done in days. At step 1235, a task (“TASK”) is also created based on the WL Entry. In at least some embodiments, the context of the task is the WL Entry. As represented at step 1240, the task shows on the outpatient Wait List (“OUTPT WL”) and in at least some embodiments is of Type:Outpt WL.

In order to actually provide the outpatient service to the patient, the service must usually be scheduled, and thus an appointment for the service is generally required. The system is ready for at least one appointment to be booked at step 1245, when a user creates the appointment (“APPT”) in the system. In at least some embodiments, every offer is logged or otherwise recorded, with such recordation preferably including at least the appointment that is booked and manual entry of communication with the patient, and canceled appointments and reschedules likewise being recorded. The patient's arrival for an appointment is represented at step 1250. During the course of the patient's outpatient treatment, the patient may have multiple visits, including an initial visit (sometimes referred to as the “check in appointment” or “arrival visit”), a final visit (sometimes referred to as the “check out visit” or “discharge visit”), and additional visits in between. On the other hand, the service may only involve a single visit by the patient, in which case the visit serves as both the arrival visit and the discharge visit. These visits, and the logging or other recordation thereof by in the system, are represented at steps 1255 and 1260. In at least some embodiments, the outpatient discharge visit, as represented at step 1260, causes the automatic completion of the WL Entry (i.e., it no longer appears on the Wait List). Furthermore, the outpatient clock stops at this point. Finally, the Outpt WL task is marked as completed at step 1265, and assuming at step 1270 that no surgery is required, the outpatient service process 1200 is complete.

If, at step 1270, elective surgery is to be provided, an additional process 1300, related to but in at least some embodiments different from the outpatient service process 1200, is initiated. As an initial matter (not shown), a form, requesting admission, is completed, preferably by the surgery provider. Then, at step 1305, a user initiates an elective surgery Wait List entry, and at step 1310 an elective surgery WL Entry is created. This WL Entry is linked to the existing referral created at steps 1110 and 1115. In at least some embodiments, this is defined to the system as being a WL Entry of Type: Elective Surgery(Visit), and such type may be selected by the user during the creation process. As with the outpatient Wait List entry, a corresponding clock (“CLOCK”) is preferably initiated in conjunction with the creation of the elective surgery WL Entry; the clock may be dependent upon the Urgency category. At step 1315, a task (“TASK”) is also created based on the WL Entry. In at least some embodiments, the context of the task is the WL Entry. As represented at step 1320, the task shows on the elective surgery Wait List (“Elective Surgery WL”) and in at least some embodiments is of Type:Visit or Type: Elective Surgery(Visit).

At this point, the system is ready for the surgery to be scheduled, at step 1325, and for any necessary pre-admittance testing to be scheduled at step 1330. It will be appreciated that the surgery time may be negotiated with the patient, or it may be assigned to the patient without negotiation. In at least some embodiments, every offer is logged or otherwise recorded, with such recordation preferably including at least the appointment that is booked and manual entry of communication with the patient, and canceled appointments and reschedules likewise being recorded. During the course of the patient's elective surgery treatment, the patient may have visits for pre-admittance testing or the like in addition in addition to the actual surgery. The patient's arrival for a pre-admittance testing visit is represented at step 1335, and the patient's arrival for a surgical visit is represented at step 1350. Furthermore, for either or both of the pre-admittance testing and the actual surgery, the patient may have multiple visits, including an initial visit (sometimes referred to as the “check in appointment” or “arrival visit”), a final visit (sometimes referred to as the “check out visit” or “discharge visit”), and additional visits in between. On the other hand, the testing or surgery, respectively, may only involve a single visit by the patient, in which case the visit serves as both the arrival visit and the discharge visit. These visits, and the logging or other recordation thereof by in the system, are represented at steps 1335 and 1340 (for pre-admittance testing) and at steps 1355 and 1360 (for actual surgery). In at least some embodiments, when a disposition is selected for the surgery discharge visit, as represented at step 1360, the WL Task is also updated. Furthermore, the surgery clock stops at this point. Finally, the Surgery WL task is marked as completed at step 1365, and the elective surgery process 1300 is complete.

Notably, in at least some embodiments, clinical input is needed as to whether follow-up treatment is warranted. If so, follow-up appointments may be booked directly, without WL involvement. However, they may be linked to the original referral.

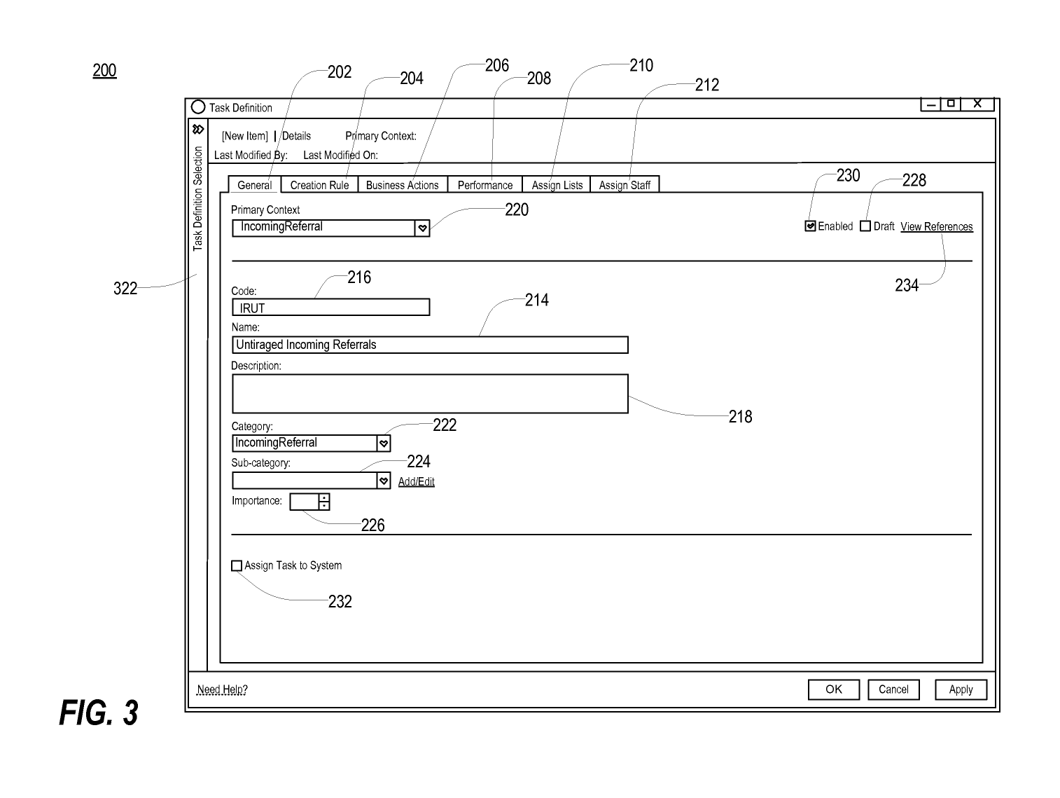

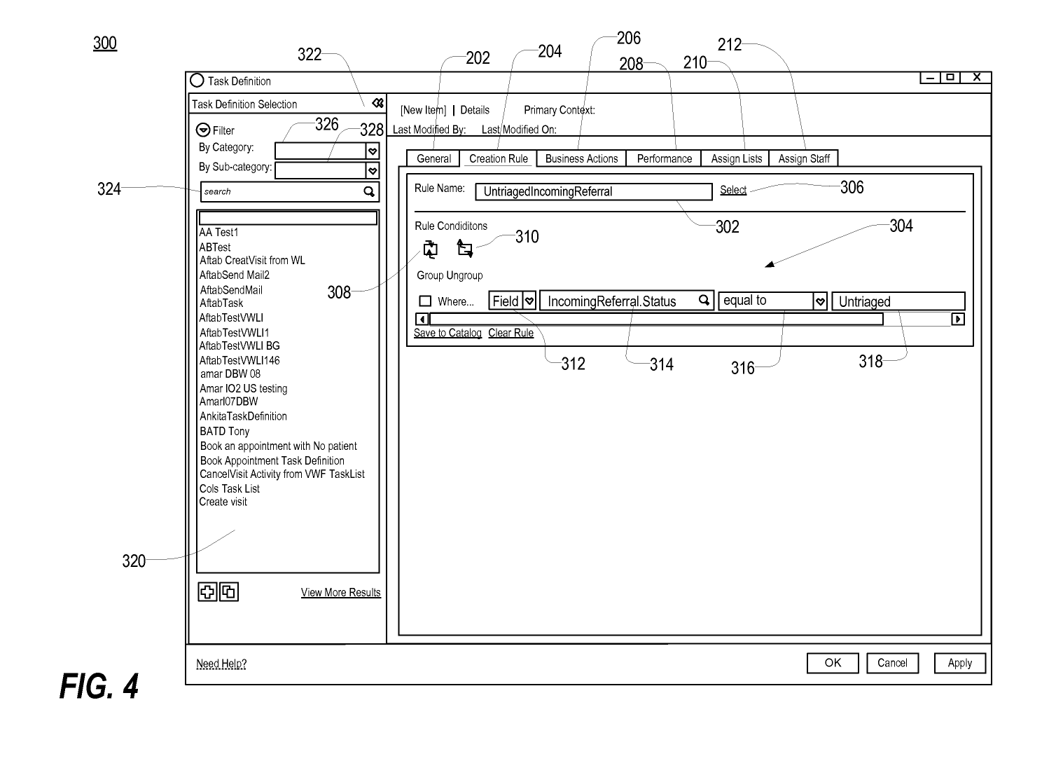

In carrying out an Incoming Referral life cycle such as the exemplary one depicted in FIGS. 2A, 2B, and 2C, a useful advantage provided by the innovation is providing users the ability to specify criteria to be used in the creation of tasks, with responsibility for the completion of such tasks being assigned to specific people based on other user-defined criteria. In a contemplated commercial embodiment, the mechanism through which the task criteria are defined and the task lists are generated and worked is the Visual Workflow (VWF) platform, available from Allscripts. Such a VWF platform is described in the '224 application. Within VWF, users may have the ability to perform all the steps necessary for the creation of an Incoming Referral task list. For example, within VWF, users may have the ability to attend to task list definition and its criteria, as shown in FIGS. 3 and 4.

Although more fully described in the '224 application, an excerpt from such patent application is set forth below. The VWF platform is a visual platform for optimizing and customizing work processes using visually composable parts usable by subject matter experts (SME's) in the domain who are likely not skilled in developing software. This platform allows these SME's to orchestrate the composable parts into working software which meets their distinct functional requirements in a visual manner similar to process diagramming techniques with which they may already be familiar. This allows for the manipulation of core features of software (events, activities, tasks, rules, and entities/data) in a visual manner to customize applications or to create new applications.

In one or more preferred implementations, such a platform is implemented by dividing elements of software applications into tools which are usable by many constituents of differing technical and non-technical knowledge and aptitude to create and alter software functionality. In one or more preferred implementations, these tools include: an Event Manager, which is a tool configured to visually associate events with their actions and a runtime component to process those events and the associated subscriptions; a Rule Manager, which is a tool configured to visually create reusable rule definitions and a runtime component to execute those rule definitions against data to determine a result; a Workflow Manager, which is a tool configured to visually create process diagrams which are executable software applications made up of composable elements orchestrated in the order prescribed to meet the functional requirement, and includes a runtime component for executing those workflow diagrams across people, places, and time; a Scheduler, which is a tool configured to visually schedule work to be completed at a later date or on a recurring basis, as well as a runtime component to execute that work on the defined schedule; and a Task Manager, which is a tool configured to visually create and assign “To Do” lists of work and a runtime for managing and tracking that work, including robust metrics and reporting. FIG. 1 of the '224 application illustrates these tools, and provides a general overview of interactions therebetween.

The Task Manager tool provides task management functionality. FIG. 10 of the '224 application schematically illustrates an exemplary Task Manager tool and its relationship to other tools and components, and FIG. 11 of the '224 application illustrates an exemplary task management architecture.

Task management allows clients to configure automatic identification of work (tasks) that commonly occur, specify conditions for resolution, and specify assignment to a worker or team of workers for resolution. Preferably, clients are also able to define a layout of task lists, the priorities and metrics for Task completion, monitor the progress of work toward its resolution and adjust assignments or priorities when conditions change. Task definition and discovery preferably use Business Rules and Business Events separately or in combination to widen or narrow the inclusion of Tasks. Task discovery can also occur by examining a population of business data on a periodic or ad-hoc basis. Task lists are preferably configured using a set of common properties for display and sort attributes and can be left open to allow users to tailor the list to their needs or locked to prevent tailoring. A built-in set of standard task actions (resolve, reject, close, transfer, etc) are preferably assignable by permission and enforce consistent treatment of in-flight tasks. Workers can preferably also utilize a special “ask for help” task to get assistance from other workers and/or teams, which maintains the chain of tasks assignments and resolutions in a cascading manner. A configurable role based Task Workbench can include Task Lists, Workload Management and Performance Monitoring panels to give a real time access to pending, in progress and completed work for individual users and or teams.

Task management can be characterized as being divisible into the following component portions.

A first of these portions involves defining the work. This defines the nature of each unique kind of Task, including identification attributes, business rules that define the characteristics of the problem, rules that define the item assignment logic, resolution instructions, item management details for controlling reappearance (i.e. delay or prevent a resolved task from being added if the original business conditions still exist), and any performance requirements.

Another of these portions involves assigning the work. Assignment of work is preferably two part: tasks are assigned to a list, then the lists are assigned to workers and/or teams. This is believed to provide greater flexibility in definition, management and monitoring of tasks than a fixed definition.

Another of these portions involves discovering the work. Work discovery can occur when a Business Event is raised, on a periodic basis using a “discovery” activity which filters and inspects business data, or manually on request by a user or a workflow. In the case of a Business Event being raised; one or more Tasks of the same or different type can be spawned with a single Event. Configurable Discovery activities can be run on a regular or ad-hoc basis against a population of business data to locate conditions that indicate that work needs to be completed. Tasks can also be created manually by users or as a step in a workflow.

Another of these portions involves carrying out the work. Workers at all levels of the organization can be assigned work to do based on their association with one or more Task Lists. Depending on their permissions, workers may or may not be able to sort their list(s) on various columns, and work their assigned tasks in any sequence. Tasks can typically be worked one after the next in the natural sequence of the list by simply completing the last step in a Task to move onto the first step in the next task.

Another of these portions involves managing a user's work. A user, based on their permissions, may be able to skip over tasks, reject or reassign tasks to others, close tasks individually or in bulk and perform other standard actions.

Another of these portions involves managing a user's staff's work. As a supervisor or manager, a user can assign and reassign work among the workers on the teams the user has accountability for.

Another of these portions involves tracking performance. As a worker, a user has visibility into the user's own performance against the volume of work and the performance standards for that work. As a supervisor or manager, a user has visibility into the user's team or teams. A user can configure a variety of Performance Monitor dashboards by selecting appropriate data items and data ranges and choosing from among a variety of charting types to plot the selected data. These dashboards can be for a user's own use, or assigned to a user's team members to aid them in understanding their performance.

Task Lists and Performance Monitor components are preferably capable of being embedded within other applications that reside on the VWF platform (or other platforms, including one or more platforms available from Allscripts).

In one or more preferred implementations, a task manager can be utilized, for example, to create a task definition to search for accounts over a certain balance (say $1000) which have not had a payment within a certain period of time (say 60 days). This task discovery definition could be run on a periodic (say weekly) basis to identify routine late payments. If an organization is inundated with work, they may choose to adjust the balance upward, or if AR days is creeping up, they may adjust the amount or time period downward. In either case when this task discovery activity is run, individual Tasks will be created and assigned to the specified task list. Workers or teams of workers can be associated with the task list and these task items will be included in their mix of work in the correct sequence based on established priorities. If conditions change in the middle of a shift, the lists can be unassigned, effectively removing the tasks from the workers lists, causing them to work the then highest priority items.

In accordance with the present invention, the Task Manager tool and VWF platform may be utilized to provide an incoming referrals management solution. In this regard, FIG. 3 is a screenshot of a first exemplary task definition screen 200 in a graphical user interface in accordance with one or more aspects of the present invention. There may be several different task definition screens. For example, the particular task definition screen 200 illustrated in FIG. 3 is one of six available in this graphical user interface, and is accessible via a graphical tab 202, labeled “General,” located along the top of the screen 200. Other tabs 204,206,208,210,212 (and corresponding task definition screens) available include ones labeled “Creation Rule,” “Business Actions,” “Performance,” “Assign Lists,” and “Assign Staff.” On the “General” screen 200, various aspects of a task list are defined. In particular, the screen 200 includes a name field 214, a short code field 216, a field 218 for any desired description of the task list, a primary context field 220, a category field 222, a sub-category field 224, and a relative importance field 226. One or more status fields 228,230,232 may be provided to indicate and/or control whether the task list being defined is in draft form, is enabled for use, is to be assigned to the system, or the like. In the illustrated screen, the task list name 214 is “Untriaged Incoming Referrals,” the short code 216 is “IRUT,” the primary context 230 is “IncomingReferral,” the task list has been placed in the “IncomingReferrals” category 222 but no sub-category 224 has been assigned, its importance 226 has not been assigned, and the task list enablement field 230 has been set (thereby making it available for use).

In at least some embodiments, sub-categories may be added and/or edited. Also in at least some embodiments, an option 234 may be provided to view references.

FIG. 4 is a screenshot of a second exemplary task definition screen 300 in a graphical user interface in accordance with one or more aspects of the present invention. The particular task definition screen 300 illustrated in FIG. 4 is another of six available in this graphical user interface, and is accessible via the graphical tab 204, labeled “Creation Rule,” located along the top of either of the screens 200,300 of FIGS. 3 and 4. On the “Creation Rule” screen 300, various aspects of a rule for creation of a task are defined, including its name and conditions. A particular rule may be selected for viewing or editing by clicking on a link 306 that displays a list of existing rules. The name of the rule may be displayed in a name display field 302. Various tools for editing the rule conditions may be provided, including an interface 304 for establishing conditions for the rule and controls 308,310 for grouping or ungrouping rule conditions. The interface 304 for establishing conditions preferably allows a user to select the particular parameter type 312, a particular parameter 314 of that type, a comparison type 316, and the condition 318 to which the parameter 314 is being compared using the comparison type 316. In the illustrated screen 300, the rule displayed for editing in the name display field 302 is “UntriagedlncomingReferral.” In the sole condition shown for this rule, the parameter type 312 is “Field,” the particular parameter 314 is “IncomingReferral.Status,” the comparison type 316 is “equal to,” and the condition 318 to which the parameter (the “IncomingReferral.Status” field 314) is to be compared is “Untriaged.” In other words, the rule “UntriagedlncomingReferral” includes everything whose “IncomingReferral.Status” field is “equal to” “Untriaged.”

Also in FIG. 4, the tasks that have been defined within the particular system (and are thus available in the Incoming Referral life cycle described previously) are included in a long list 320 that has been displayed by clicking the “Task Definition Selection” button or area 322 along the left side of the screen 300 of FIG. 4 or the screen 200 of FIG. 3. In many cases, the list 320 of available tasks may be so long that not all of the tasks can be shown at once. In at least some embodiments, other tasks may be displayed by simply scrolling the list 320, but in at least some embodiments the tasks may be filtered or searched. In the interface shown in FIG. 4, a search tool 324 is provided, as well as a category selector tool 326 and a sub-category selector tool 328. With regard to the search tool 324, entering text in an input field of the search tool 324 may result in all tasks that include the entered text being displayed. With regard to the category selector tool 326 and sub-category selector tool 328, clicking on the tool 326,328 may result in the display of a list of categories and sub-categories, respectively, and subsequent selection of a particular category and/or sub-category, from the respective list, may result in the display of all tasks in that category or sub-category.

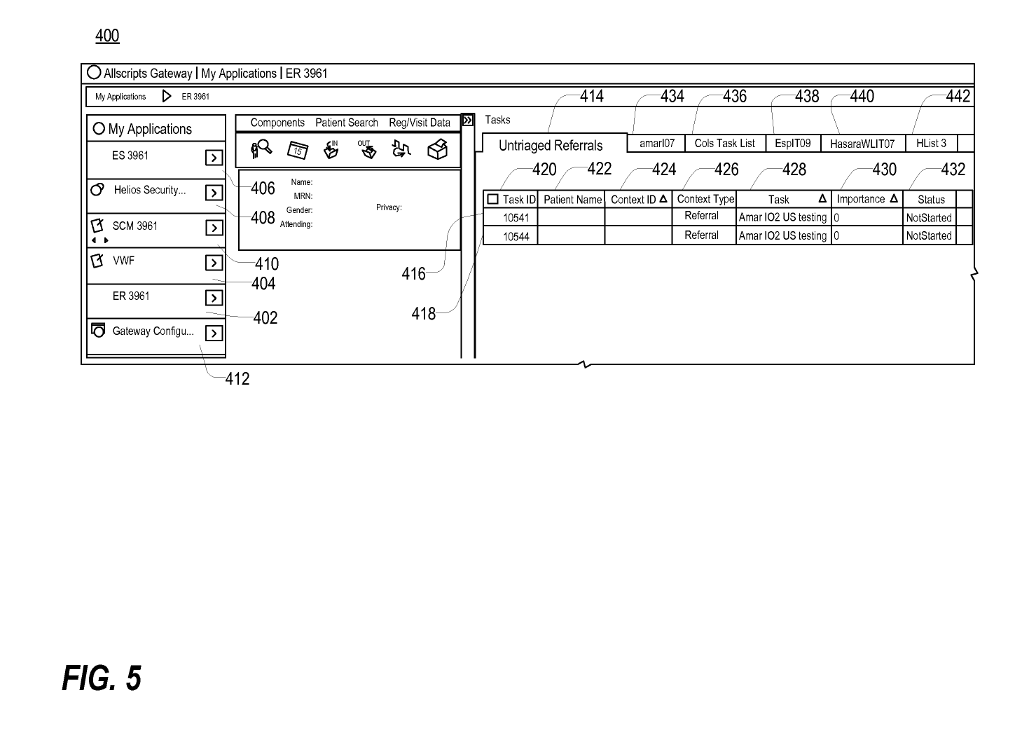

In at least some embodiments, after the VWF configuration is complete, users may be able to see their tasks in enterprise software applications, such as an enterprise registration application, an enterprise scheduling application, or the like. In this regard, FIG. 5 is a screenshot of a portion of a screen 400 in an exemplary graphical user interface for an enterprise registration application in accordance with one or more aspects of the present invention. As shown therein, an enterprise registration application 402, labeled “ER 3961,” has been selected from a plurality of application options, which otherwise include the visual workflow application 404 (labeled “VWF”), an enterprise scheduling application 406 (labeled “ES 3961”), a security services application 408 (labeled “Helios Security . . . ”), a clinical information software application 410 (labeled “SCM 3961”), and a system configuration application 412 (labeled “Gateway Configu . . . ”).

Within the enterprise registration application 402, open tasks may be viewed and otherwise managed. For example, graphical tools may be provided (such as the graphical depiction of task lists accessible via labeled tab, as shown in FIG. 5) to organize the tasks assigned to particular individuals, or that are untriaged incoming referrals, thereby making it easy for a user to view his or her own task list or to view untriaged referrals. In the screenshot of FIG. 5, a tab 414 labeled “Untriaged Referrals” has been selected, and two tasks 416,418 corresponding to untriaged referrals are displayed. Attributes of the tasks 416,418 include a task identification number (“Task ID”) 420, the name of the patient to whom they correspond (“Patient Name”) 422, a context identifier (“Context ID”) 424, a context type (“Context Type”) 426, a textual description of the task (“Task”) 428, a level of importance (“Importance”) 430, a status (“Status”) 432, and the like. For example, the first task 416 in the category of untriaged referrals has Task ID 10541, a context type of “Referral,” a task description of “Amar IO2 US testing,” an importance of “0,” and a status of “NotStarted.”

Similar task lists, each corresponding to a particular user, could alternatively be selected by selecting a different tab, wherein other tabs displayed in this example include “amarIO7” 434, “Cols Task List” 436, “EspIT09” 438, “HasaraWLIT07” 440, and “HList 3” 442. From within their designated task list a user will have the ability to work an individual task through the use of context menus. After the task has been worked, VWF may evaluate the Incoming Referral against user-defined criteria and, depending on whether the criteria have been met, may carry out various steps. Such steps may include one or more of completing the task, reassigning the task, completing the task and creating another one, leaving the task open and assigned to the current user, and the like.

In some embodiments, software implementing the processes, functions, tools, and features described herein may be provided as an add-on feature to other software products, including enterprise software products. Additionally or alternatively, software implementing the processes, functions, tools, and features described herein may be offered as a standalone product or product component.

Based on the foregoing description, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention.

Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements, the present invention being limited only by the claims appended hereto and the equivalents thereof.

What is claimed is:

1. A computer-implemented method of using task lists to manage incoming referrals in a medical care organization, comprising:
presenting, to a user via a display screen associated with a first electronic device, a user interface of a task manager configured to visually create and assign lists of work corresponding to an incoming referral process;
receiving, from a user via one or more input devices associated with the first electronic device, input corresponding to visual creation and assignment of a list of work corresponding to an incoming referral process;
presenting, to a user via a display screen associated with a second electronic device, a user interface of a wait list manager configured to visually create a wait list entry based upon an incoming referral in a medical care organization;
receiving, from a user via one or more input devices associated with the second electronic device, input, based on the incoming referral, corresponding to creation of a wait list entry;
creating the wait list entry based upon the incoming referral input;
creating one or more tasks based upon the wait list entry; and
automatically managing and tracking, by a runtime software component based at least in part on the received input corresponding to visual creation and assignment of a list of work, the tasks created based upon the wait list entry, thereby driving the incoming referral process.

2. The method of claim 1, wherein the step of automatically managing and tracking the tasks based upon the wait list entry includes assigning tasks to specific people based on criteria received as part of the input corresponding to the visual creation and assignment of the list of work.

3. The method of claim 2, wherein the context of at least one of the one or more tasks that are created is based on the wait list entry.

4. The method of claim 2, wherein the wait list entry is an outpatient service wait list entry, and wherein the wait list entry is displayed visually via the user interface of the wait list manager in an outpatient service wait list.

5. The method of claim 2, wherein the wait list entry is an elective surgery wait list entry, and wherein the wait list entry is displayed visually via the user interface of the wait list manager in an elective surgery wait list.

6. The method of claim 2, wherein the step of automatically managing and tracking the tasks includes updating the wait list entry status based on the execution of activities related to the task.

7. The method of claim 6, wherein the step of automatically managing and tracking the tasks includes updating the wait list entry status based on a patient appointment.

8. The method of claim 7, wherein the step of automatically managing and tracking the tasks includes updating the wait list entry status based on an appointment for an outpatient service.

9. The method of claim 7, wherein the step of automatically managing and tracking the tasks includes updating the wait list entry status based on an appointment for elective surgery.

10. The method of claim 7, wherein the step of automatically managing and tracking the tasks includes updating the wait list entry status based on an appointment for pre-admittance testing.

11. The method of claim 7, wherein the step of automatically managing and tracking the tasks includes updating the wait list entry status based on the creation of a patient appointment.

12. The method of claim 7, wherein the step of automatically managing and tracking the tasks includes updating the wait list entry status based on a patient arrival visit.

13. The method of claim 7, wherein the step of automatically managing and tracking the tasks includes updating the wait list entry status based on a patient discharge visit.

14. The method of claim 7, wherein the step of automatically managing and tracking the tasks includes updating the wait list entry status based on the creation of a patient appointment.

15. The method of claim 2, further comprising a step of initializing a clock in conjunction with the step of creating the wait list entry.

16. The method of claim 15, wherein the clock measures time in units of days.

17. The method of claim 15, wherein the clock is used to measure the length of time required for completion of at least one task.

18. The method of claim 2, wherein the step of automatically managing and tracking the tasks based upon the wait list entry includes evaluating, after a task has been performed by a specific person, the incoming referral against user-defined criteria to determine further action.

19. The method of claim 18, wherein the further action includes marking the task as complete.

20. The method of claim 18, wherein the further action includes reassigning the task to a different person.
